(19) United States
(12) Patent Application Publication
(10) Pub. No.: US 2007/0201316 A1
(43) Pub. Date: Aug. 30, 2007

(54) Positive & negative directions independent driving and displaying wristwatch structure

(76) Inventor: Tieh-Cheng Shu, Hemei Township (TW)

Correspondence Address: TROXELL LAW OFFICE PLLC;SUITE 1404, 5205 LEESBURG PIKE, FALLS CHURCH, VA, 22041, US

(21) Appl. No.: 11/583,974

(22) Filed: Oct. 20, 2006

(30) Foreign Application Priority Data
Dec. 12, 2005 (TW) 094221152

(51) Int. Cl. G04C 17/00; G04B 25/00

(52) U.S. Cl. 368/223

(57) ABSTRACT

A positive & negative directions independent driving and displaying wristwatch structure, which sets two groups of numbered face in reverse direction on face of wristwatch, each numbered face has hour, minute and second hand, wherein the independent active shaft respectively drives each group of hands, so that they can rotate in reverse direction, namely, as one hands group rotates clockwise while another hands group rotates anticlockwise, thereby, it is very interesting to watch time, moreover, owing to the clockwise and anticlockwise rotating numbered faces, you can get directly the correct left time by visual confirmation, which therefore promotes the operating function of wristwatch accordingly.

### BACKGROUND OF THE INVENTION

1. Field of the Invention

This invention relates to a positive & negative directions independent driving and displaying wristwatch structure, which sets independent driving hands group and numbered face in reverse direction on face of wristwatch, so that it is convenient to confirm the time difference between the normal and future time through direct vision.

2) Description of the Prior Art

Numbered face of usual wristwatch is arranged in single direction, though this model of wristwatch marks clear graduations and numbers or partial graduations, whatever it is, such structure can only display normal time, thereby, appearance and operating function are simple without significant characteristics. Some types of wristwatch promote their function by second hand and depth to resist water, however, above said functions are not practical though you may be surprised at first glance; thereby, the current wristwatch on sale often attracts costumers by its colorful design in strap; the colorful metal or leather strap can indeed beautify appearance of wristwatch, however, its function is single (without any added function), namely, only displays time, so, its function is limited.

### SUMMARY OF THE INVENTION

### 1. Problem to Solve

1. Usual wristwatch pays more attention to design of appearance and strap, however, its operating function still halts at visual effect of normal time, thereby, it only has visual aesthetic feeling without any progress in operating function.

2. A usual multi-functional wristwatch is at most added second hand or depth to resist water, however, such function is not a popular special function, so, it is not practical, furthermore, its structure is complicated and expensive, which are the main reason why most customers can not receive it.

3. If want to know the left time from the wristwatch with common structure, you need to watch the normal time and then make calculation by yourself, such method is inconvenient and incorrect, besides, such calculation can be done correctly only o'clock, at other time, it is difficult to calculate and easy to make mistake.

### 2. Solutions

(1) The independent driving active shaft of this invention which respectively controls two hands group to rotate in reverse direction makes positive & negative directions independent driving and displaying wristwatch structure by use of numbered face in reverse direction, so that you can watch two kinds of time at same time.

(2) Basing on the two kinds of time-displaying mode of this invention, it is easy for you to determine the left time between the normal time and the appointed or set time, so that you can make best use of the time.

(3) Owing to the application of two kinds of time-displaying mode, user can select the visual effect according to one's own requirement, furthermore, it can also make wristwatch be more colorful and fashionable.

### BRIEF DESCRIPTION OF THE DRAWINGS

FIG. 1 is the exploded view of structure of this invention.

FIG. 2 is the combined operating sketch map of structure of this invention.

FIG. 3 is the driving sketch map of structure of this invention.

FIG. 4 is the turning sketch map of hands group of this invention.

FIG. 5-A is the sketch map of aligned hands group of this invention.

FIG. 5-B is another sketch map of aligned hands group of this invention.

FIG. 6-A is the sketch map of main and secondary face with hands of this invention.

FIG. 6-B is another sketch map of main and secondary face with hands of this invention.

### DETAILED DESCRIPTION OF THE PREFERRED EMBODIMENTS

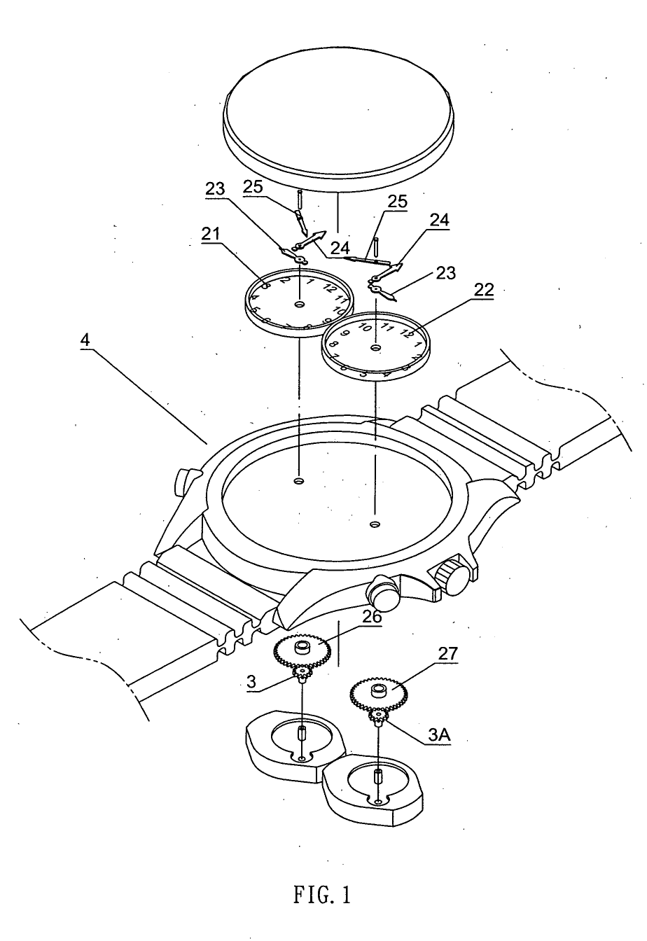

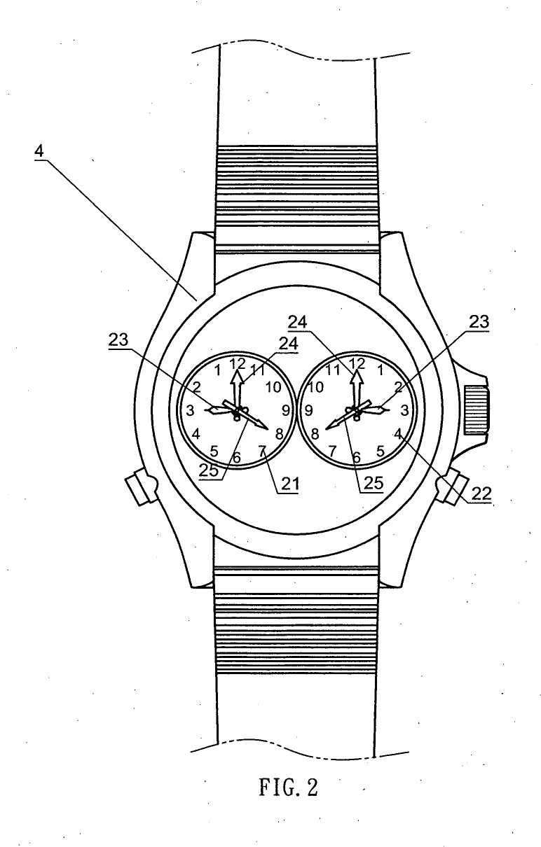

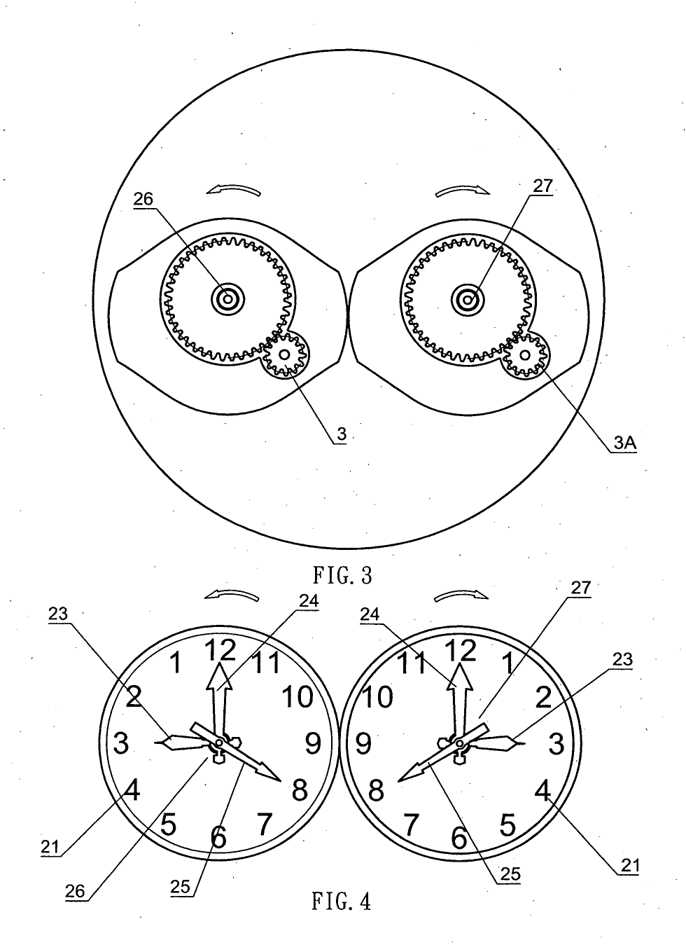

First of all, please refer to FIG. 1, FIG. 2, FIG. 3 and FIG. 4, features of this invention are as follows:

Two groups of numbered face 21 and 22 in reverse direction are set on face of wristwatch 2, each numbered face has hour hand 23, minute hand 24 and second hand 25, wherein the independent active shaft 3 and 3A respectively drive hands group 26 and 27, active shaft 3 in positive direction driving drives hands group 26 to rotate anticlockwise by mesh; and active shaft 3A in negative direction driving drives hands group 27 to rotate clockwise (see FIG. 4 for detail), so that two hands groups 26 and 27 rotate in reverse direction, thus, a special double-hand displaying wristwatch 4 is made, it will be interesting to watch time (see FIG. 2 for detail).

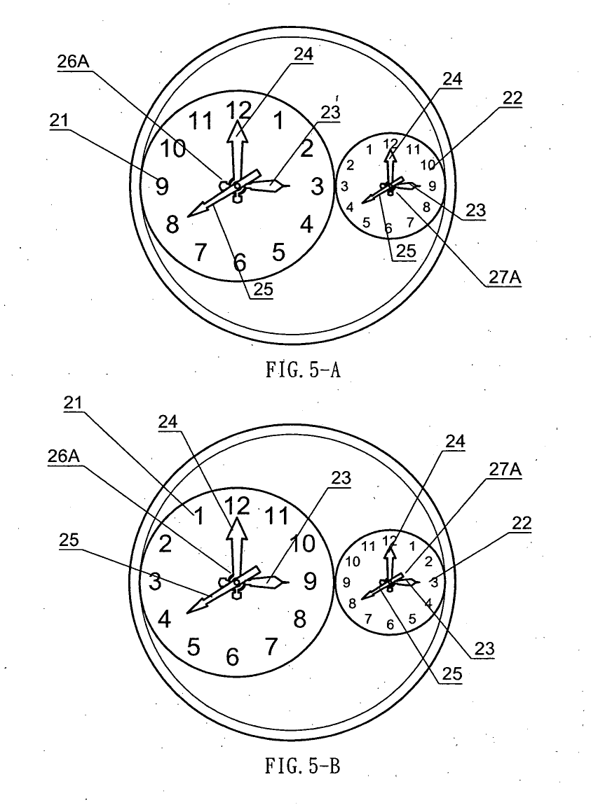

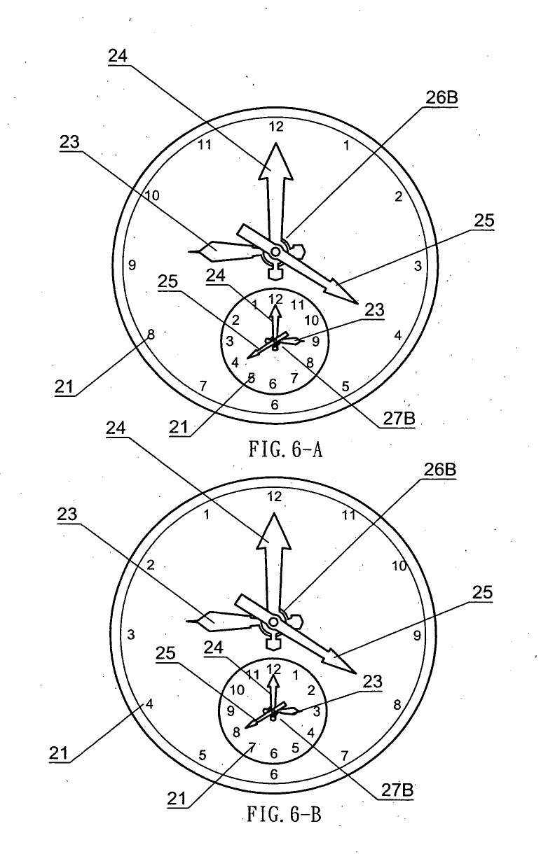

In addition, please refer to FIG. 5-A, FIG. 5-B and FIG. 6A, FIG. 6-B, this invention can align the two groups of numbered face 21 and 22 in reverse direction or arrange them according to their sizes; as left hands group 26A rotates clockwise, numbered face 21 is arranged clockwise, however, right hands group 27A rotates anticlockwise, its numbered face is also arranged anticlockwise (see FIG. 5-A for detail); if left hands group 26A rotates anticlockwise, its numbered face 21 is arranged anticlockwise, and right hands group 27A rotates clockwise, its numbered face 22 is also arranged clockwise (as shown in FIG. 5-B); if set the two numbered faces in reverse direction as main face and secondary face, as hands group 26B of main face rotates clockwise, its numbered face 21 is also arranged clockwise, and hands group 27B of secondary face at this time rotates anticlockwise, and its numbered face 22 is arranged anticlockwise (refer to FIG. 6-A); however, if hands group of main face 26B rotates anticlockwise, its numbered face 21 is arranged anticlockwise, and hands group of secondary face 27B at this time rotates clockwise, its numbered face 22 is also arranged clockwise (refer to FIG. 6-B), so that it is very interesting to watch time, moreover, owing to the clockwise and anticlockwise rotating numbered face, wristwatch 4 can display several kinds of time, you can watch the left time and make direct confirmation basing on it.

What is claimed is:

1. A positive & negative directions independent driving and displaying wristwatch structure, its features are as follows:
Two groups of numbered face in reverse direction are set on face of wristwatch, each numbered face has hour, minute and second hand, wherein the independent active shaft respectively drive each group of hands, so that they rotate in reverse direction, namely, as one hands group rotates clockwise while another hands group rotates anticlockwise, thereby, it is very interesting to watch time, moreover, owing to the clockwise and anticlockwise rotating numbered faces, you can get directly the correct left time by visual confirmation, which therefore promotes the operating function of wristwatch accordingly.

2. As claimed in claim 1, wherein said two groups of numbered face in reverse direction can be arranged in upper and below or left and right alignment.

3. As claimed in claim 1, wherein said two groups of numbered face in reserve direction can be arranged according to their sizes.

4. As claimed in claim 1, wherein said two groups of numbered face in reverse direction can be set as main and secondary face in practical application.
